(19) United States
(12) Patent Application Publication
(10) Pub. No.: US 2013/0132459 A1
(43) Pub. Date: May 23, 2013

(54) INFORMATION-SHARING COMPUTER SYSTEM AND CORRESPONDING METHOD

(71) Applicant: Thierry Lamouline, Villeneuve les Avignon (FR)

(72) Inventor: Thierry Lamouline, Villeneuve les Avignon (FR)

(21) Appl. No.: 13/643,030

(22) PCT Filed: Apr. 11, 2011
(86) PCT No.: PCT/FR2011/000209

§ 371 Date: Feb. 5, 2013

(30) Foreign Application Priority Data
Apr. 23, 2010 (FR) 1001750

(51) Int. Cl. H04L 29/08

(52) U.S. Cl. CPC H04L 67/02
USPC 709/201

(57) ABSTRACT

The invention relates to a computer system that is set up to access an extended network. Said computer system is characterised in that it includes: a memory (20) that stores sharing page data; a memory (22) that stores sharing page structure data; a memory (18) that stores editor profile data; an extractor (13) that is set up to receive an access request and to extract a sharing page identifier and an editor profile identifier therefrom; a screener (14) that is set up to extract sharing page data on the basis of a sharing page identifier; an engine (16) that is set up to generate a sharing page on the basis of sharing page structure data, sharing page data, and editor profile data; and a driver (10) that is set up to receive an access request for an extended network element, is intended for calling the screener (14) with the sharing page identifier and the editor profile identifier that are predetermined by the extractor (13), is intended for calling the engine (16) with the resulting data and the sharing page structure data, and is intended for sending the resulting page back to said extended network element.

The invention relates to the field of information processing over an extended network.

The arrival of the internet has provided new channels of expression, both to individuals and to professionals in the publishing field. This process has intensified in particular by the advent of the Web 2.0, within which social networks enable information to be shared ever more rapidly.

Various technological solutions have been developed to make it easier for Internet users to share a web link of interest to their acquaintances.

However, these tools only make it possible to share elements relating to looking up on the web. There is no solution currently available enabling a reader of a printed publication to share an article or to access content associated with this article.

The invention sets out to improve the situation.

To this end, the invention proposes a computer system that is set up to access an extended network, which comprises:
a memory that stores sharing page data;
a memory that stores sharing page structure data;
a memory that stores editor profile data;
an extractor that is arranged to receive an access request and to extract a sharing page identifier and an editor profile identifier therefrom;
a screener that is arranged to extract sharing page data on the basis of a sharing page identifier;
an engine that is arranged to generate a sharing page on the basis of sharing page structure data, sharing page data, and editor profile data; and
a driver that is arranged to receive an access request for an extended network element, to call up the screener with the sharing page identifier and the editor profile identifier that are determined by the extractor, to call up the engine with the resulting data and the sharing page structure data, and to send the resulting page back to said element of the extended network.

Further features and advantages of the invention will become more apparent from a study of the description that follows, taken from examples given in an illustrative and non-restrictive capacity, taken from the drawings, wherein:

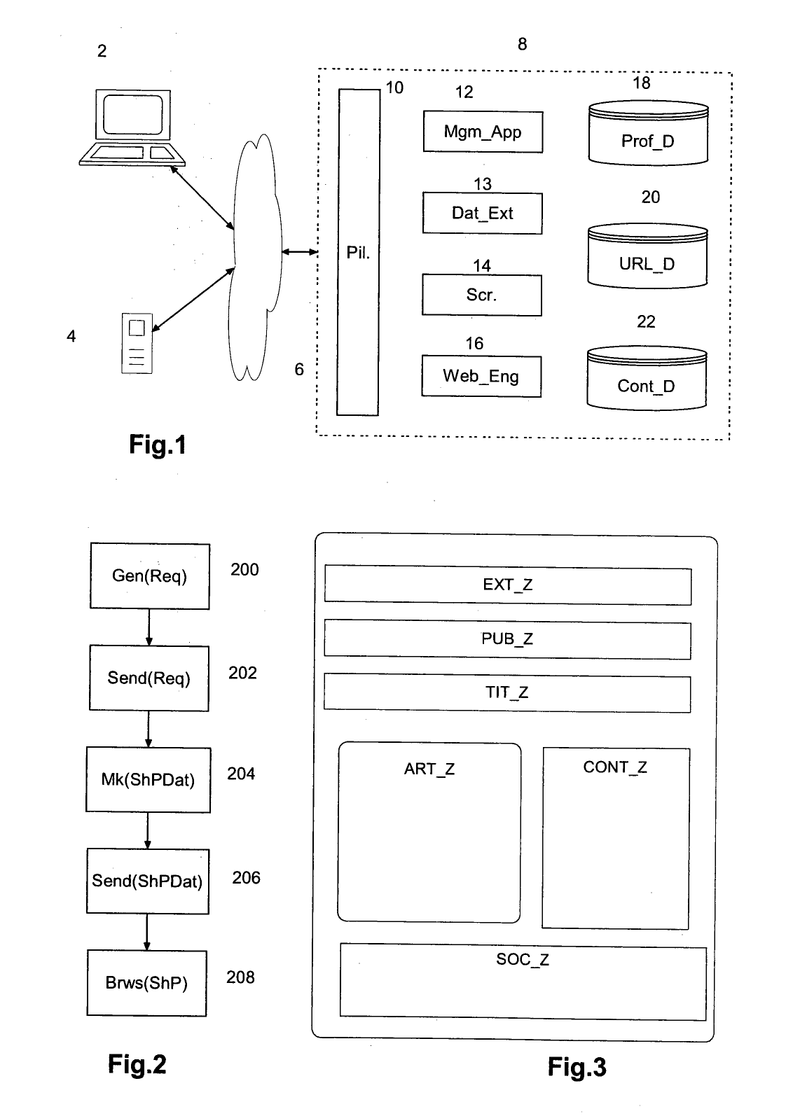

FIG. 1 shows a generic plan of a computer environment in which the invention is implemented,

FIG. 2 shows a flow diagram of access to a sharing page according to the invention,

FIG. 3 shows an example of a model of a sharing page produced according to the invention,

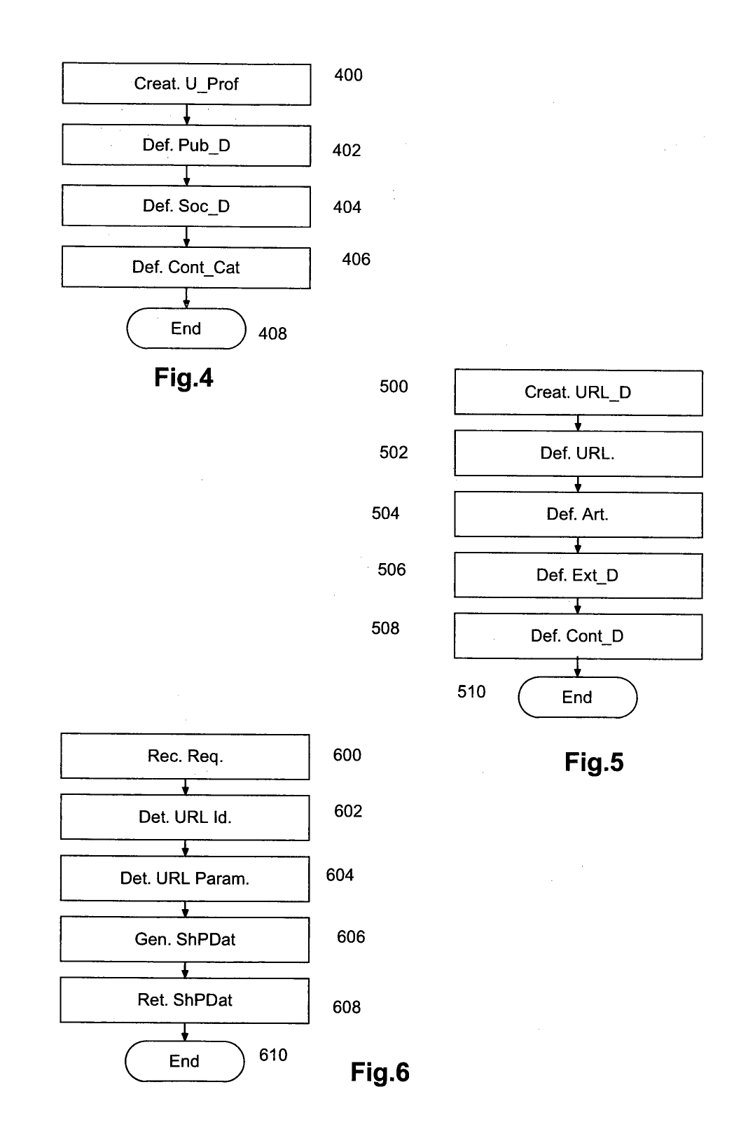

FIG. 4 shows a flow diagram of the creation and/or modification of an editor profile within the scope of the invention,

FIG. 5 shows a flow diagram of the creation and/or modification of a sharing page within the scope of the invention,

FIG. 6 shows a flow diagram of the generation of sharing page data within the scope of the invention, and

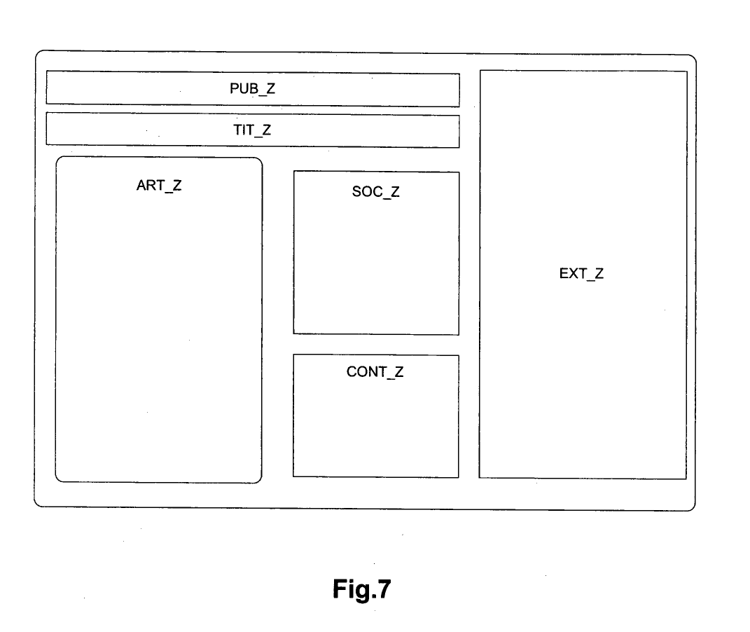

FIG. 7 shows another example of a model of a page produced according to the invention.

The drawings and description that follow essentially contain elements of a specific nature. They may therefore serve not only to assist with understanding the present invention but also contribute to its definition, in certain circumstances.

FIG. 1 is a general diagram of an environment using a system according to the invention.

In this environment, client stations 2 and 4 may communicate through an extended network 6 (for example the Internet) with a computer system 8 according to the invention.

In the embodiment described the computer stations are a laptop computer 2 and a mobile telephone 4.

However, other devices may be envisaged, such as a desktop computer or a “tablet” type computer. The main feature of these devices is their ability to connect to the computer system 8 and display the pages that it sends them.

In the embodiment described here, the computer system 8 is a single-user web server. This server may be made in any suitable form, such as a cluster of servers, possibly distributed over a number of different locations. The main feature of the server 8 is its capacity to receive requests for access to the sharing pages and to supply these pages.

In the embodiment described here, the laptop computer 2 and the telephone 4 each comprise a character recognition program. This program makes it possible to detect a string of characters in an image processed by these apparatus.

This image can be registered in the memory of these apparatus, or taken from a photo sensor of the telephone 4 or from a webcam incorporated in the portable computer 2. The computer terminals 2 and 4 also comprise a program designed to send a request for access to a sharing page on the server 8, which contains the text taken from the character recognition.

The program for requesting access and the character recognition program may be incorporated in the same program, or may constitute separate elements called up by another program.

Thus, taking the example of an application on a modern mobile telephone such as the iPhone (registered trade mark of the Apple company), an application may be made available to users.

This application is programmed for:
accessing the video feed of the photo sensor of the iPhone,
calling up a text recognition module on part of this feed, and
calling up the server 8 directly and in return displaying the sharing page.

These actions may be performed by remaining in the application and using the software modules incorporated in the iPhone. Alternatively, some or all of the code may also be rewritten. This latter option may be very advantageous, as will be seen in connection with FIG. 6.

The server 8 comprises a driver 10, a management program 12, an extractor 13, a screener 14 and an assembly engine 16, as well as memories 18, 20 and 22 for storing the profile data, sharing page data and contents data, respectively.

The memories 18, 20 and 22 may be physically connected to the server 8, or may be remotely accessible. They may be provided within a single memory or in separate memory units.

FIG. 2 shows an example of a request for access to a sharing page submitted to the server 8.

In a first operation 200, the computer device 2 or 4 generates a request for access to the sharing page. This operation is carried out by a Gen( ) function which generates the request from the string of characters obtained as described hereinbefore.

The Gen( ) function concatenates this string of characters with a string of text which forms a request template. In an embodiment described here, the server 8 is a Web server. The Gen( ) function concatenates it with the address of the server 8 to which the access requests are sent.

For example, the page that is called up for looking up a sharing page may be a “sharing_page.htm” page of the server 8. The character string with which the character string will be concatenated will thus be of the type http:/URL_Server/sharing_page.html, where URL_Server is the URL address of the server 8.

Once the two chains have been concatenated, the http request that is emitted will take the following form:

GET http://URL_Server/sharing_page.html?page=recognised_text_string

### HTTP/1.0

User-Agent: user_agent_of_the_device

Once this request has been formed by the Gen( ) function, a Send( ) function is used to send this request to the server 8 in an operation 202.

This request is received by the server 8, and in an operation 204, the server processes it and produces sharing page data that define a sharing page which corresponds to the string “recognised_text_string”, by means of functions proper to the server 8 referred to here by the function name Mk(ShPgDat).

As will be seen hereinafter, the sharing page data ShPDat may vary as a function of the origin of the request for access to the shared page. In fact, as will be seen with FIG. 6, the server 8 will not process a request from a specific application and a request from a web browser in the same way.

Then, the server 8 sends the sharing page data Sh_Pg_Dat generated in the operation 204 to the emitting apparatus 2 or 4 in an operation 206 by means of the Send( ) function.

Finally, the user is able to access the sharing page on the emitting apparatus 2 or 4 in an operation 208, via a Brws( ) function.

FIG. 3 shows a sharing page template that is filled in with information obtained from the Req request by the server 8.

The details of the generation of this page will be more readily apparent from FIG. 6. The embodiment shown here is particularly well suited to displaying on a mobile telephone.

As can be seen from FIG. 3, the sharing pages are divided into a plurality of zones:
a zone EXT_Z,
a zone PUB_Z,
a zone TIT_Z,
a zone ART_Z,
a zone CONT_Z, and
a zone SOC_Z.

The zones EXT_Z, PUB_Z and TIT_Z are vertically aligned in this order, above the zones ART_Z and CONT_Z which are substantially parallel to one another in this order, and above the zone SOC_Z.

All these zones may be filled with various types of content that can vary according to parameters established by the editor of the sharing page.

The purpose of the zone Ext_Z is to receive elements outside the context of the shared page and designated by the creator of the page. For example, this zone may receive publicity data which may enable the editor to be remunerated as the data are consulted. Moreover, the content of these pages may be personalised as a function of the data supplied by the editor of the sharing page and the provider of the publicity pages.

The purpose of the zone Pub_Z is to receive data that make it possible to identify the editor of the sharing page. For example, when the sharing page is a page linked to a magazine article, the zone Pub_Z may receive a logo of the magazine or of the magazine editor, as well as links to a subscription page or the like. In the example described here, this zone is common to the sharing pages created by one editor.

The purpose of the zone Tit_Z is to receive data that make it possible to identify the sharing page. This may be for example a title possibly associated with a content. This zone is entirely dynamic, i.e. it changes with each new sharing page. Of course, it is still possible to use identical data for the Tit_Z zones of two separate sharing pages.

The purpose of the zone Art_Z is to receive data that constitute the main content of the sharing page, i.e. the object of the sharing page itself. This may be for example a photo accompanied by a text that summarises the article, this zone forming a hypertext link that leads to the real address of the article that is the subject of this sharing page. Here again, this zone is entirely dynamic, i.e. it changes with each new sharing page. Again, it is still possible to use identical data for the Art_Z zones of two separate sharing pages.

The purpose of the zone Cont_Z is to receive content data associated with the article presented in the zone Art_Z. These contents may be photos, videos, a link to a discussion forum on the article, one or more links to articles dealing with the same subject, etc. The description of FIG. 4 will show that the content may be particularly varied and, once again, dynamic.

Finally, the purpose of the zone Soc_Z is to receive social sharing data of this sharing page. More precisely, this zone may receive two types of sharing elements:
on the one hand, links to social networking sites (for example Facebook, Twitter, Digg, an email account, etc.) which will make it easy for the user to share the address of the article to which the sharing page relates with their acquaintances. The links to social networking sites are not simple redirections to the home page of the site in question: they also contain the control parameters necessary for sharing that are required by each site in question. They could be interpreted as being requests.
on the other hand, one or more backup links which allow the user to register this page among their favourites in a service connected to the server 8 to which the user subscribes, to enable it to be consulted at a later stage with easier access.

Like the zone Pub_Z, the zone Soc_Z is common to the sharing pages created by the same editor, in the example described here.

As will be better shown by FIGS. 4 to 6, these zones may be filled dynamically and very easily thanks to the architecture of the invention.

As seen previously, the sharing pages follow a presentation prototype or template, which is fixed here, and the editor “fills in” the zones as necessary.

However, the editor may be required to create several dozens, or even hundreds, of sharing pages. In this context, it is useful to create editor profiles on the server 8, in which the editor can centralise a certain amount of data that will be valid for all the sharing pages that he creates, thereby reducing his workload.

Thus, FIG. 4 describes a function of creating/updating an editor profile for centralising this information. In the example described here, this function is performed by a web page on the server 8 (or on another server) accessed by the editor. This is the management program 12 which manages these pages as well as the scripts and access to the memories 18, 20 and 22.

In other embodiments, a program may be run locally on a machine belonging to the editor, which executes the same operations as those described by FIG. 4, and synchronises these data with the editor profile on the server 8 later on.

In an operation 400, the editor profile U_Prof is created. When an editor comes to modify his profile later, this operation will be an authentication process, for example using the pairing of the editor name and password.

Then, in an operation 402, the editor has access to a page that enables him to define the data Pub_D of the zone Pub_Z.

As has already been described previously, these data are common to the pages that are created by the editor, and they enable him to be identified clearly, for example by means of a logo and/or a name.

In the example described here, these data comprise a logo, which the editor can upload directly onto the server 8, or indicate by reference by giving a link to another server on which this logo is accessible, and two hypertext links.

The logo must be of a size limited by the outline adopted for the shared page, as shown in FIG. 3. This guarantees that the editor cannot produce wrongly formatted pages by uploading a logo that is too big. Alternatively, the server 8 may comprise an application that resizes a logo when it is too big. The image data may for example be stored in the memory 22.

The two hypertext links may be personalised by the editor to guide a user towards links of interest, For example, one of the links may be personalised to guide the user towards a subscription page to the paper content of the editor, and the other link may take the user to a page that enables him to subscribe to news feeds relating to the editor, such as an RSS feed or an electronic newsletter.

Generally speaking, these two links are links of a textual nature chosen arbitrarily by the editor.

Then, in an operation 404, the editor may define data Soc_D for the zone Soc_Z. The data Soc_Z will relate to the two types of links described above. Advantageously, this page may take the form of a selection page on which each social network is accompanied by an icon identifying this network and a box of the “radio button” or “check box” type for selecting the corresponding network.

Once the editor has made a selection from all the sharing elements via social networks or the backup that he wishes to submit, identifiers of these networks are registered in the editor's profile.

Thus, each time the sharing zone Soc_Z is activated in a sharing page, this page will display the icons of the social networks selected by the editor. These icons will themselves be hypertext links which the user can click on, as described previously.

20

From here, the user can share the address of the article to which the sharing page relates with his contacts, either by directly sending a message containing this address, or by publishing this address in his status page, for example.

Finally, in an operation 406, the editor can define content category data. In fact, it has been seen from FIG. 3 that the zone Cont_Z is dedicated to linking contents chosen by the editor.

These contents may be of various types:
photo,
video,
forum,
comment,
RSS feeds,
special offer linked to the article,
etc.

The editor can create as many categories as he wishes. Optionally, certain categories may be created by default and cannot be deleted, for example “photo” and “video”.

In the zone Cont_Z, these categories will appear when they are provided as a button in a predetermined format, containing a text describing the name of the category, and constituting a link which leads to an address containing the content associated with this category.

Optionally, the editor may assign a default value to the address associated with each of the categories. Thus, if one of the categories is a forum, for example, the editor may integrate the address of this forum directly and automatically, without having to recreate it each time.

Then the creation/modification of the editor profile is terminated in an operation 408.

In the example described above, each operation is carried out by a specific web page, which makes it possible to categorise the actions of the editor, while keeping to a reasonable size that avoids the need for complex navigation over the screen to ensure that all the required fields have been completed.

However, all these operations may be combined on a single-page form. Moreover, the operations shown above may be carried out in any order. Similarly, not all the operations are required in order to create and/or modify a profile. Some can be omitted as a function of the editor's needs.

FIG. 5 describes a function of creating/updating a sharing page by an editor. In the example described here, this function is performed by a web page on the server 8 (or on another server) accessed by the editor. Here again, it is the management program 12 that manages these pages and the scripts and access to the memories 18, 20 and 22.

In other embodiments, a program may be run locally on a machine belonging to the editor, which performs the same operations as those described in connection with FIG. 5, and which synchronises these data with the sharing page data on the server 8 later.

In an operation 500, a sharing page profile URL_D is created. When the editor comes to amend this sharing page later, this operation will be an operation of authentication, for example using a pairing of an editor name/password and the inputting of an identifier of the sharing page (by manual inputting or by selecting using the mouse, for example).

Then, in an operation 502, the editor inputs the address at which the sharing page can be accessed.

According to a first alternative embodiment, the address of the sharing page may be a composite between a global address assigned to the editor of the type http://URL_Editor/and a particular address that the editor chooses for the sharing page.

This type of address convention has a number of advantages.

First of all, it enables a certain homogeneity to be given to the sharing pages created by the editor. This means that a user can identify the editor not only by the data in the Pub_Z zone, but also by the first part of the URL address of the sharing page.

Also, it reduces the quantity of data that the editor has to enter to create a sharing page. This represents a time saving that is by no means negligible (the URLs may take some time to write, because of the special characters that they contain), but also acts as a safeguard, as the risks of typing errors connected with the first part of the URL are eliminated.

Finally, this allows easier processing by the server when it receives a request for access to a page: this makes it possible to search directly in the sharing pages published by a given editor, instead of searching through all the sharing pages created.

In other alternative embodiments, it will be possible for the editor to define the address of the sharing page, partly or in its entirety.

The operation 502 is followed by an operation 504 in which the editor is able to define data Art_D for publication in the zones Tit_Z and Art_Z.

The data Art_D may comprise, on the one hand, title data for the article, which is displayed in the zone Tit_Z, between the data of the zone Art_Z and the data of the zone Pub_Z, and on the other hand data relating to the article that the editor wishes to display on the sharing page.

The data of the article may comprise an image the size of which is limited by a frame, similar to that used for the editor's logo, accompanying text and a hypertext link to the article itself.

In the embodiment described here, this image is a miniature of the article to which the sharing page relates. This reassures the user as to the page that he is about to share with his contacts. This miniature may be generated automatically on the creation of the sharing page by the editor, or may be generated each time it is looked up by a user. Of course, these data are not all necessary, and the hypertext link on its own may be sufficient. The image data may for example be stored in the memory 22.

Then, in an operation 506, the editor may define data Ext_D for filling in the zone Ext_Z. Generally these data are formed by one or more URL addresses which contain the name of an advertising agency, and an identifier of the editor (optional), depending on the agency's operating methods.

It goes without saying that other contents may be designated by the addresses of the data Ext_D, the idea being that these data designate a content that is not necessarily under the editor's control.

Finally, in an operation 508, the editor may define data Cont_D for filling in the zone Cont_Z.

This operation may comprise two steps:
in a first step, the editor chooses the categories of content that have to be displayed for the sharing page,
in a second step, the editor fills in the content of the categories that he has chosen in the first step.

In fact, this content may be varied as a function of the sharing page under consideration. The first step thus allows this selection to be made, the basic choice of which corresponds to the categories of content defined in the editor profile.

This first step may also provide a maximum number of categories, to preserve the legibility of the sharing page. In this first step, the editor may also activate or deactivate the content of the zone Soc_Z by ticking a box, depending on whether or not the editor wishes the user to be able to share the page.

The second step consists in specifying, for each of the categories selected in the first step, the hypertext link associated with them, if it is not predefined (cf. operation 406).

It will be noted that, thanks to the possibilities of modern codes, both steps may be carried out without reloading the page, which simplifies the editor's tasks and improves the ergonomics of the page.

Finally, this operation terminates at 510.

In a similar manner to FIG. 4, each operation in the embodiment described above is carried out by a specific web page, thus making it possible to categorise the editor's actions while maintaining a reasonable size, thus avoiding the need for complex navigation around the screen to ensure that all the required fields have been completed.

However, all these operations may be combined on a single-page form. Moreover, the operations described above may be carried out in any order. Similarly, not all the operations are required in order to create and/or modify a profile. Some may be omitted, as a function of the editor's needs.

Now that the structure of the sharing pages is clearly apparent in accordance with the profile of the editor creating them, FIG. 6 will help explain how access to a sharing page is managed by the server 8.

In a first operation 600, the server 8 receives the request for access to a sharing page. This operation is the result of the operation 202 in FIG. 2.

Then, in operations 602 to 606, we will describe an embodiment of the implementation of the function Mk(Sh_P) of the operation 204.

In the operation 602, the driver 10 calls the extractor 13 of the server 8 to analyse the access request received in operation 600, which extracts from it the editor profile identifier (first part of the URL address of the request) and the identifier of the sharing page at which this request (second part of the URL address of the request) is aimed.

Then, in the operation 604, the driver 10 calls the screener 14 of the server 8 to request the sharing page data memory 20 and find out whether the sharing page identifier extracted from the request is contained therein.

Then, if this identifier is found, the corresponding sharing page data are recovered. If not, the screener 14 sends back an error message which is relayed to the emitting device 2 or 4.

In a first alternative embodiment, the screener 14 may determine the sharing page identifier closest to that taken from the extractor 13, and the corresponding sharing page data.

In a second alternative embodiment, the screener 14 is able to determine a plurality of sharing page identifiers close to that taken from the extractor 13, and ask the user to choose from among these identifiers.

These same operations are also carried out on the editor profile identifier in the memory 18 to recover the sharing page data that are common to the sharing pages of the same editor.

Once all the data relating to the sharing page have been recovered, the driver 10 processes the sharing page data obtained in the operation 604 in an operation 606.

To do this, in a first period the driver 10 sets out to determine whether or not it should call up the engine 6 to generate the sharing page. This distinction may for example be implemented on the basis of the “User Agent” information contained in the request of the operation 600.

In fact, when the invention is performed using a mobile device such as a portable telephone, the latter may contain an application specific to looking up the sharing pages of the invention, so that there is no need to format the data of the operation 606, except by compiling them in the file ShPDat, and sending them to the requesting apparatus in an operation 608.

In this case, the mobile telephone application comprises an engine adapted to receive the data ShPDat in raw form and to display the corresponding sharing page in accordance with the diagram in FIG. 3.

To do this, this engine uses sharing page structure data that form a canvas corresponding to FIG. 3, and generates the sharing page, introducing the sharing page data ShPDat mentioned in the previous paragraph. In the example described here, these data are stored in the memory 22.

In the example described here, the canvas of the sharing page is in the XML language. This canvas describes frames for each zone described hereinbefore. These frames define identified classes of content.

Similarly, the sharing page data taken from the memories 18, 20 are also in the XML language, and comprise identifiers corresponding to those of the classes of the canvas. Thus, these elements are integrated in the zones corresponding to them when the engine integrates them in the canvas.

This is particularly advantageously for several reasons.

First of all, this environment makes it possible to reduce the amount of data transmitted to the apparatus, which is advantageous in terms of cost and processing time.

Moreover, as it is the application on the apparatus itself that is tasked with displaying the sharing page. Consequently, there is only one application to update and adapt for each operating system.

This is advantageous when one realises the extent of the divergence in processing of the HTML code by the various web browsers on the market. It is all the more true since the engine of the application only has to display a single type of page and it is not very complex.

When the driver 10 determines that the request of the operation 600 comes from a web browser, it calls up the engine 16 to generate the sharing page, in a similar manner to that described for the engine of the mobile telephone. The ShPDat data then consist of the sharing page itself.

Finally, once the engine 16 has constructed the sharing page corresponding to the request of the operation 600, the driver 10 sends this page to the apparatus that has submitted the look-up request in the operation 608.

FIG. 7 shows a variant of a canvas for the sharing page which is more suited to looking up on a computer or a tablet.

For this purpose, the server 8 stores sharing page structure data for each canvas. The engine 16 may for example determine the canvas to be applied as a function of the “User Agent” information contained in the request of the operation 600. This may be done for example during the operation 606. Thus, if the “User Agent” information indicates, for example, that the request comes from the Web browser of a tablet, the engine 16 could generate the adapted sharing page. In this case the request of the operation 600 may be sent through the Web browser, by entering the string of text corresponding to the sharing page in the browser's address bar.

1. Computer system arranged to access an extended network comprising:
a memory that stores sharing page data,
a memory that stores sharing page structure data,
a memory that stores editor profile data,
an extractor that is arranged to receive an access request and to extract a sharing page identifier and an editor profile identifier therefrom,
a screener that is arranged to extract sharing page data on the basis of a sharing page identifier;
an engine that is arranged to generate a sharing page on the basis of sharing page structure data, sharing page data, and editor profile data, and
a driver that is arranged to receive an access request for an element of the extended network, to call the screener with the sharing page identifier and the editor profile identifier that are determined by the extractor, to call the engine with the resulting data and the sharing page structure data, and to send the resulting page back to the element of the extended network.

2. Computer system according to claim 1, further comprising a management program arranged to enable an editor to define editor profile data for storing in the editor profile data memory.

3. Computer system according to claim 2, wherein the editor profile data comprise data selected from among the editor image data, the editor name data, the social networking site data and the category data.

4. Computer system according to claim 1, wherein the management program is further arranged to enable an editor to define sharing page data for storage in the sharing page data memory.

5. Computer system according to claim 4, wherein the sharing page data comprise data selected from among the title data, article data, category data, sharing data, external data and contents data.

6. Computer system according to claim 5, wherein at least some of the sharing page data comprise a hypertext link associated with a text and/or a display image.

7. A computer environment comprising:
a computer system comprising:
a memory that stores sharing page data,
a memory that stores sharing page structure data,
a memory that stores editor profile data,
an extractor that is arranged to receive an access request and to extract a sharing page identifier and an editor profile identifier therefrom,
a screener that is arranged to extract sharing page data on the basis of a sharing page identifier;
an engine that is arranged to generate a sharing page on the basis of sharing page structure data, sharing page data, and editor profile data, and
a driver that is arranged to receive an access request for an element of the extended network, to call the screener with the sharing page identifier and the editor profile identifier that are determined by the extractor, to call the engine with the resulting data and the sharing page structure data, and to send the resulting page back to the element of the extended network;
a computer device comprising a text recognition module
a network communications interface, and
an application arranged so as to call up the computer system through said network communications interface with a request for access to a sharing page, the request comprising data extracted from said text recognition module.

8. Computer environment according to claim 7, wherein the device further comprises an image data acquisition module, and wherein the said application is arranged so as to call up said text recognition module with image data extracted from said image data acquisition module in order to generate the request for access to a sharing page.

9. Computer environment according to claim 8, wherein the image data are extracted from a paper magazine.

10. Computer environment according to claim 9, wherein the application comprises an engine arranged so as to generate a sharing page from sharing page data, and wherein the driver is arranged so as to receive an access request from an element of the extended network, to call up the screener with the sharing page identifier and the editor profile identifier determined by the extractor, and to send the resulting data to said apparatus without calling up the engine.

11. Computer environment according to claim 8, wherein the computer system further comprises a management program arranged to enable an editor to define editor profile data for storing in the editor profile data memory.

12. Computer environment according to claim 11, wherein the editor profile data comprise data selected from among the editor image data, the editor name data, the social networking site data and the category data.

13. Computer environment according to claim 8, wherein the management program is further arranged to enable an editor to define sharing page data for storage in the sharing page data memory.

14. Computer environment according to claim 13, wherein the sharing page data comprise data selected from among the title data, article data, category data, sharing data, external data and contents data.

15. Computer environment according to claim 14, wherein at least some of the sharing page data comprise a hypertext link associated with a text and/or a display image.
